(19) United States
(12) Patent Application Publication
(10) Pub. No.: US 2005/0105763 A1
(43) Pub. Date: May 19, 2005

(54) Real time video watermarking method using frame averages

(76) Inventors: Seung Wook Lee, Busan (KR); Jin Ho Kim, Daejeon (KR); Wonyoung Yoo, Daejeon (KR)

Correspondence Address: JACOBSON HOLMAN PLLC, 400 SEVENTH STREET N.W., SUITE 600, WASHINGTON, DC, 20004, US

(21) Appl. No.: 10/901,073

(22) Filed: Jul. 29, 2004

(30) Foreign Application Priority Data
Nov. 14, 2003 (KR) 10-2003-0080639

(51) Int. Cl. G06K 9/00

(52) U.S. Cl. 382/100

(57) ABSTRACT

The present invention relates to a watermarking method for protecting the copyright of digital data, which includes the step of dividing each of two successive frames into at least two sub-groups, the step of adding and subtracting a value, which varies according to pixel locations, to and from a specific component value at each pixel location of the sub-groups using Just Noticeable Difference (JND) values and averages of the specific component value at pixel locations of corresponding sub-groups of the two successive frames, the step of adaptively embedding watermark information while modifying embedment intensity of the watermark information, the step of calculating the averages of the specific component values of the sub-groups, and the step of extracting watermark information using the calculated averages.

### FIELD OF THE INVENTION

The present invention relates to a watermarking method for protecting the copyright of digital data; and more particularly, to a method of embedding and extracting watermarks into and from video data in real time using frame averages, which increases the non-transparency and capacity of the watermarks in the video, into which the watermarks are embedded, using the characteristic of a human visual system in space and time, and which is implemented to be robust to a geometric attack.

### BACKGROUND OF THE INVENTION

Recently, as access to digital contents becomes easier due to the development of network infrastructures, e.g., the Internet, a digital technology is applied to almost all fields ranging from the generation and distribution of contents to the editing of the contents.

The development of such digital technology produces various spread effects, such as the diversification of contents and the improvement of convenience. However, as concern for the infringement of copyrights of digital contents through the illegal copying of the digital contents increases due to the characteristics of the digital contents, a content protection technology, such as Digital Rights Management (DRM), have been proposed.

DRM refers to a technology of protecting, securing and managing digital contents. That is, the DRM refers to a technology, which prohibits the illegal use of distributed digital contents, and continuously protects and manages the rights and profits of copyrighters, license holders and distributors related to the use of the digital contents. In such DRM, one of the techniques required to protect copyrights is a watermarking technique.

When contents are packaged using the DRM technology, watermarked contents are packaged together, so that the copyright can be protected by the watermarking technique preceding the packaging of the digital contents. The watermarking technique is a method of protecting an original copyright by embedding ownership information, which cannot be identified by the vision or hearing of a human, into digital contents, such as text, images, video and audio, and extracting the ownership information therefrom in the case where a copyright dispute occurs.

To fully realize the function of the watermarking technique, the watermarking technique must be robust to various types of signal processing. That is, to protect copyrights, the watermarking technique must be robust to all types of attacks attempting to remove watermarks. It has been known that there are two types of watermark removal attacks. One is a waveform modification attack, and the other is a geometric attack. For the waveform modification attack, if the watermarks are embedded in the middle frequency or low frequency band, it can be expected that the watermarks become robust against the processing accompanying the modification of a waveform, such as compression, filtering, averaging, and noise addition. However, the above-described method cannot cope with the geometric attack. Especially, the watermarking technique needs to be robust to a geometric attack, which destroys the synchronization of the watermark signal embedded in the host image by introducing local and global changes to the image coordinates, so that the watermarks cannot be extracted.

By such necessities, there have been researched and developed a technique of embedding watermarks into regions that are not changed after being attacked, and a technique of embedding predetermined patterns in advance. Furthermore, there have been developed a technique of extracting feature points and embedding watermarks using the feature points, and a technique of embedding watermarks by normalizing images.

However, the aforementioned techniques are disadvantageous in that it takes excessive time to embed and extract watermarks due to pre-processing and post-processing, and they are weak to an attack, such as compression. Furthermore, the aforementioned techniques are disadvantageous in that resynchronization is required to correctly extract a watermark message, but the resynchronization requires excessive time, which makes real-time processing difficult.

### SUMMARY OF THE INVENTION

It is, therefore, a primary object of the present invention to provide a method of embedding and extracting watermarks into and from video in real time using the frame averages of luminance components, which is less influenced by a geometric attack, which modifies the averages of the luminance values of an image, based on watermark information, and embeds the modified information into respective sub-groups, thus being robust to geometric attacks, such as cropping, rotation, resizing and projection, and which uses the characteristic of a Human Visual System (HVS), thus increasing the non-transparency, capacity and processing speed of the watermarks.

It is, therefore, another object of the present invention to increase the capacity of watermarks in such a way that a single frame is divided into a plurality of sub-groups and watermarks are embedded into the sub-groups, respectively, so that the number of watermark data bits increases compared to the case of embedding a watermark into a single frame.

In accordance with a preferred embodiment of the present invention, there is provided a method of embedding watermarks into digital contents in real time using frame averages including: a first step of dividing each of two successive frames into at least two sub-groups, a second step of adding and subtracting a value, which varies according to pixel locations, to and from a specific component value at each pixel location of the sub-groups using Just Noticeable Difference (JND) values and averages of the specific component value at pixel locations of corresponding sub-groups of the two successive frames, and a third step of adaptively embedding watermark information while modifying the embedment intensity of the watermark information. In the embodiment of the present invention, a luminance value at each pixel location, which is less influence by a geometric attack, is used as the specific component value.

In accordance with another preferred embodiment of the present invention, there is provided a method of extracting watermarks into and from digital contents in real time using frame averages, including: a first step of dividing each of two successive frames into at least two sub-group, a second step of calculating averages of specific component values of the sub-groups, and a third step of extracting watermark information using the calculated averages.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram illustrating a real-time video watermarking method according to a preferred embodiment of the present invention, which, in particular, shows a process of embedding watermarks;

FIG. 2 is a block diagram illustrating a real-time video watermarking method according to a preferred embodiment of the present invention, which, in particular, shows a process of extracting the watermarks; and

FIG. 3 is a view showing the case of dividing each of successive frames into four groups and embedding watermarks into the four groups, respectively, according to an embodiment of the present invention.

### DETAILED DESCRIPTION OF THE PREFERRED EMBODIMENTS

Preferred embodiments of the present invention will now be described in detail with reference to the accompanying drawings.

The technical gist of the present invention is to modify frame averages, which are less influenced by a geometric attack, in space using watermark signals and JND, which is one of the characteristics of a HVS, and then replace the modified frame averages with original data. From this technical spirit, the objects of the present invention will be easily achieved.

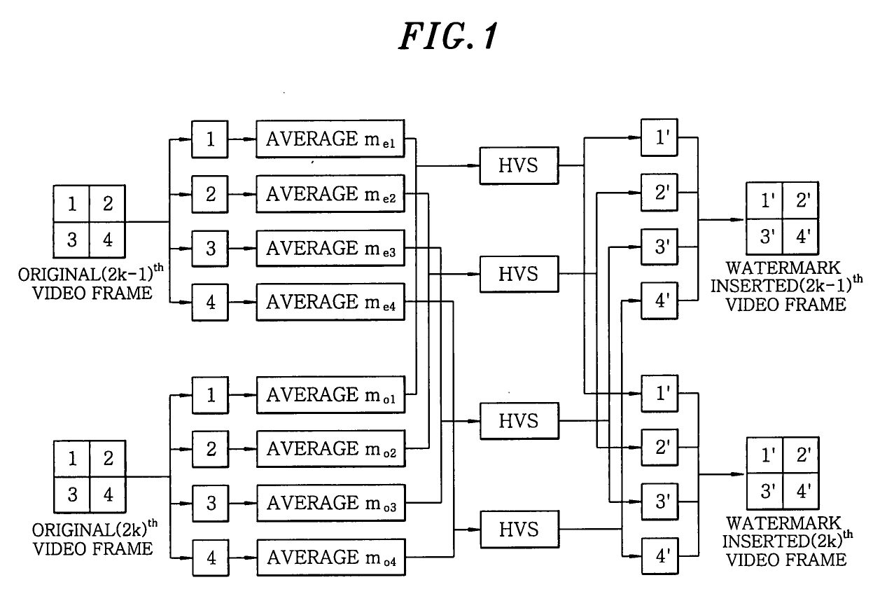

FIG. 1 is a block diagram illustrating a real-time video watermarking method according to a preferred embodiment of the present invention, which, in particular, shows a process of embedding watermarks.

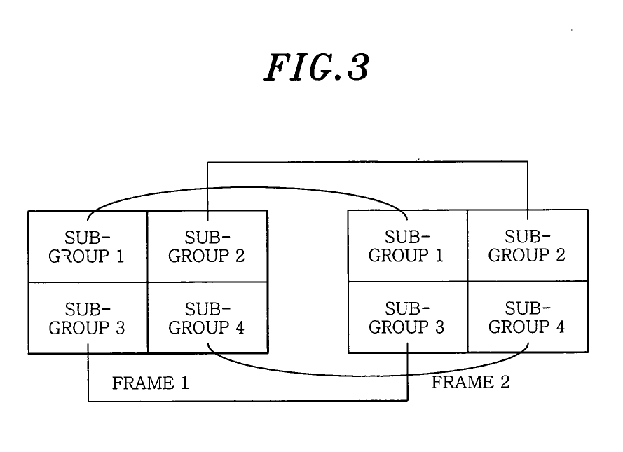

To embed watermarks, an original frame is divided into at least two sub-groups. For example, each of two original frames is divided into four sub-groups as shown in FIG. 3, and watermarks are embedded into the four sub-groups, respectively. With this operation, a total of four bits are embedded into the two original frames.

Thereafter, an even frame fₑ is divided into four sub-groups f_{e,1}, f_{e,2}, f_{e,3} and f_{e,4}, and the averages of luminance values of the sub-groups are defined as mₑ₁, mₑ₂, mₑ₃ and mₑ₄, respectively. For an odd frame fₒ, the same operation is performed. In this case, “e” and “o” indicate “even” and “odd,” respectively.

Before modifying the averages of the luminance values of a frame for the embedment of a watermark, JND, which is one of the characteristics of a HVS and is used in the present invention, is first described in brief below.

Complicated JND values over the whole range of the human vision can be calculated by the following Equation 1 proposed by Larson.

$$log ( Δ L ( {L}_{a} ) ) = \{ \begin{matrix}- 2.86 & if log ( {L}_{a} ) < - 3.94 \\ {( 0.405 log ( {L}_{a} ) + 1.6 )}^{2.18} - 2.86 & if - 3.94 \leq log ( {L}_{a} ) < - 1.44 \\ log ( {L}_{a} ) - 0.395 & if - 1.44 < log ( {L}_{a} ) \leq - 0.0184 \\ {( 0.249 log ( {L}_{a} ) + 0.65 )}^{2.7} - 0.72 & if - 0.0184 \leq log ( {L}_{a} ) < 1.9 \\ log ( {L}_{a} ) - 1.255 & if log ( {L}_{a} ) \geq - 1.9\end{matrix} \qquad ( 1 )$$

The meaning of Equation 1 is as described below.

If a patch whose luminance component value is Lₐ+ΔLₐ exists on a background whose luminance component value is Lₐ that is somewhat different from that of the patch, the patch can be identified by the human vision. However, a patch whose luminance value is Lₐ+ε(ε<ΔLₐ) exists on the background, the patch cannot be identified by human vision.

Using such a characteristic, watermark information is embedded through the following process.

The JND values of luminance values at the pixels of even and odd frames fₑ and fₒ are calculated using Equation 1.

According to a conventional method, the embedment of watermarks is performed while modifying averages to fulfill the condition of Equation 2. In this case, Δ is a value determining the intensity of the embedment of the watermark, which will be described in detail later.

$$\{ \begin{matrix}{m}_{oi}^{′} = \frac{( {m}_{oi} + {m}_{ei} )}{2} + \frac{Δ}{2} \& {m}_{ei}^{′} = \frac{( {m}_{ei} + {m}_{ei} )}{2} - \frac{Δ}{2} & if watermark = 1 \\ {m}_{oi}^{′} = \frac{( {m}_{oi} + {m}_{ei} )}{2} - \frac{Δ}{2} \& {m}_{ei}^{′} = \frac{( {m}_{ei} + {m}_{oi} )}{2} + \frac{Δ}{2} & if watermark = - 1\end{matrix} \qquad ( 2 )$$

Meanwhile, to fulfill the condition of Equation 2, a method of adding or subtracting an identical value for each frame is generally used, in which case flickering noise is generated. To reduce the flickering noise, an adaptive value is added or subtracted for each of the pixels of each frame using JND, rather than adding or subtracting an identical value for each frame.

In this case, to calculate the adaptive value, a process as shown in Equation 3 is performed. For the convenience of representation, the following equations are represented without indices i indicating sub-groups. However, the following equations are identically applied to the corresponding sub-groups of two successive frames, that is, the i-th sub-group of an odd frame and the i-th sub-group of an even frame. That is, the unit of processing, into and from which watermark information is embedded and extracted, may be the entire frame or each sub-group.
fₒ′(x,y)=fₒ(x,y)+a(x,y), a(x,y)=α·ΔLₒ(x,y) (3)

The luminance value fₒ′(x,y) at location (x,y), where the watermark is embedded, is obtained by adding a value, which varies according to pixel locations, to the luminance value fₒ(x,y) at the location (x,y) of an original frame. The value, which varies according to pixel locations, is proportional to ΔLₒ(x,y) that is the JND value of the luminance value fₒ(x,y).

If the value of the watermark is “1,” Equation 4 is obtained by adding the two sides of Equation 3, respectively, for the entire of a sub-group with a width M and a length N, and applying Equation 2.

$${m}_{o}^{′} \cdot M \cdot N = {M}_{o} \cdot M \cdot N + A = \frac{( {m}_{o} + {m}_{e} + Δ ) MN}{2} \qquad ( 4 )$$

where A is aΣΣΔLₒ(x,y), mₒ and mₑ are averages obtained before the JND value is added and subtracted, respectively, and mₒ′ and mₑ′ are averages obtained after the JND value is added and subtracted, respectively. By applying A=aΣΣΔLₒ(x,y) to Equation 4, an amplification coefficient α can be obtained as shown in FIG. 5.

$$α = \frac{( {m}_{e} - {m}_{o} + Δ ) / 2}{{\sum }^{} {\sum }^{} Δ {L}_{o} ( x , y )} \cdot M \cdot N \qquad ( 5 )$$

Similarly, the above-described process can be applied to the fₑ. The formula of watermark embedment is fₑ′(x,y)=fₑ(x,y)+b(x,y), b(x,y)=β·ΔLₑ(x,y), and

$${m}_{e}^{′} \cdot M \cdot N = {m}_{e} \cdot M \cdot N + B = \frac{( {m}_{o} + {m}_{e} - Δ ) MN}{2}$$

can be obtained by adding the two sides, respectively, for a sub-group. An amplification coefficient β is represented by Equation 6.

$$β = \frac{( {m}_{o} - {m}_{e} - Δ ) / 2}{{\sum }^{} {\sum }^{} Δ {L}_{e} ( x , y )} \cdot M \cdot N \qquad ( 6 )$$

As a result, the resulting formula of the watermark embedment is represented by the following Equation 7. In this case, M and N indicate the width and length of each sub-group, respectively.

$${f}_{o}^{′} ( x , y ) = {f}_{o} ( x , y ) + \frac{0.5 \times ( {m}_{e} - {m}_{o} + Δ ) \cdot M \cdot N}{\sum \sum Δ {L}_{o} ( x , y )} \cdot Δ {L}_{o} ( x , y ) \\ \begin{matrix}{f}_{e}^{′} ( x , y ) = {f}_{e} ( x , y ) + \frac{0.5 \times ( {m}_{o} - {m}_{e} - Δ ) \cdot M \cdot N}{\sum \sum Δ {L}_{e} ( x , y )} \cdot \\ Δ {L}_{e} ( x , y ) ifwatermark = 1\end{matrix} \\ \begin{matrix}{f}_{o}^{′} ( x , y ) = {f}_{o} ( x , y ) + \frac{0.5 \times ( {m}_{e} - {m}_{o} - Δ ) \cdot M \cdot N}{\sum \sum Δ {L}_{o} ( x , y )} \cdot \\ Δ {L}_{o} ( x , y ) if watermark = - 1\end{matrix} \\ {f}_{e}^{′} ( x , y ) = {f}_{e} ( x , y ) + \frac{0.5 \times ( {m}_{e} - {m}_{o} + Δ ) \cdot M \cdot N}{\sum \sum Δ {L}_{e} ( x , y )} \cdot Δ {L}_{e} ( x , y ) \qquad ( 7 )$$

Finally, when a watermark is embedded using Equation 7, and the embedment intensity Δ is adaptively modified using a method described below.

The absolute value Δₘ of the difference between the averages of the luminance values at the pixel locations of the corresponding sub-groups of two frames is defined as Δₘ=|mₒ−mₑ|. Additionally, the embedment intensity Δ is modified as in Equation 8 by comparing the defined average difference value with previously defined critical values.
Δ′=0.8×Δ if Δₘ<th₁
Δ′=0.9×Δ if th₁≦Δₘ<th₂ or Δ′=scaling_{—}factor·Δₘ
Δ′=1.0×Δ if th₂≦Δₘ<th₃
Δ′=1.1×Δ if Δₘ≧th₃ (8)

In this embodiment, for an example, th₁ is 0.1, th₁ is 0.2, and th₃ is 0.3.

Furthermore, in the case where a scene change occurs, Δₘ may be excessively large, so that a watermark is not embedded and the next frame is processed. For this purpose, a condition, as shown in Equation 9, is set.
if Δₘ>th then go to the next frame (9)

In this embodiment, for an example, th is 10. That is, if the condition of Equation 9 is fulfilled, it is determined that there is a scene change, so that the watermark is not embedded and the next frame is processed.

As shown in FIG. 3, it was previously described that the above-described method could be performed on each of sub-groups after dividing a frame into the sub-groups to increase the capacity of watermarks. In this case, it was previously described that the i-th sub-group of an odd frame and the i-th sub-group of an even frame could be processed in the same manner as the even and odd frames. As shown in FIG. 1, for example, each of frames are divided into four sub-groups, a sub-group of an odd frame and the corresponding sub-group of an even frame are set to the unit of processing, and watermark information is embedded into each pair of the sub-groups. That is, in this case, the averages mₑ and mₒ of Equation 7 are the averages (mₑᵢ and mₒᵢ) of each pair of sub-groups, respectively, that constitutes the unit of processing, and M and N of Equation 7 are the width and length of each pair of sub-groups. Furthermore, Δₘ of Equation 8 may be differently defined according to the locations of the sub-groups in the frame.

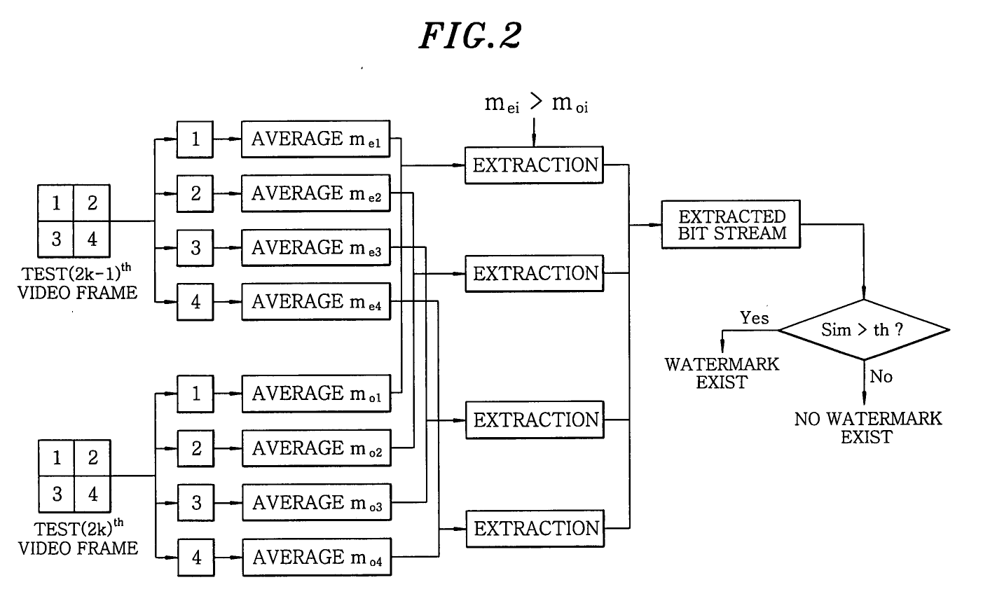

FIG. 2 is a block diagram illustrating a real-time video watermarking method according to a preferred embodiment of the present invention, which, in particular, shows a process of extracting watermark information.

Generally, there is used a method of extracting watermark information by obtaining the averages (mₑ and mₒ) of two successive test frames and then applying the averages to Equation 10.
watermark=1, if mₒ>mₑ
watermark=−1, otherwise (10)

Thereafter, the correlation value between the extracted watermark and the embedded watermark is calculated. If the correlation value is larger than a critical value, it is determined that the watermark exists.

In the case where each of two test frames is divided into a plurality of sub-groups and processed, as shown in FIG. 3, the averages mₑᵢ and mₒᵢ of the respective sub-groups are calculated, as shown in FIG. 2, Equation 10 is applied to each pair of corresponding sub-groups, and then watermark information is extracted. Thereafter, the correlation value between extracted and embedded watermarks is calculated for each pair of corresponding sub-groups, and the calculated correlation value sim is compared with a critical value th, and then it is determined whether the watermark exists or not. For example, if the correlation value sim is larger than the critical value th, as shown in FIG. 2, it is determined that the watermark exists. If the correlation value sim is not larger than the critical value th, it is determined that the watermark does not exist.

The method of the present invention is robust to not only cutting, rotation, resizing and projection attacks but also compression and filtering attacks, and the method enables embedded watermarks to be extracted even though a geometric attack is applied after compression, so that the protection of copyrights can be secured. Additionally, the method of the present invention perfectly guarantees real-time characteristics that are the requirements of a video-watermarking algorithm, so that the present invention has an effect in that watermark information can be embedded into a video broadcast in real time.

While the invention has been shown and described with respect to the preferred embodiments, it will be understood by those skilled in the art that various changes and modifications may be made without departing from the spirit and scope of the invention as defined in the following claims.

1. A method of embedding watermarks into and from digital contents in real time using frame averages, comprising:
a first step of dividing each of two successive frames into at least two sub-groups;
a second step of adding and subtracting a value, which varies according to pixel locations, to and from a specific component value at each pixel location of the sub-groups using Just Noticeable Difference (JND) values and averages of the specific component value at pixel locations of corresponding sub-groups of the two successive frames; and
a third step of adaptively embedding watermark information while modifying embedment intensity of the watermark information.

2. The method of claim 1, wherein the embedment of the watermark information is implemented by the following Equations
$${f}_{o}^{′} ( x , y ) = {f}_{o} ( x , y ) + \frac{0.5 \times ( {m}_{e} - {m}_{o} + Δ ) \cdot M \cdot N}{\sum \sum Δ {L}_{o} ( x , y )} \cdot Δ {L}_{o} ( x , y )$$
$$\begin{matrix}{f}_{e}^{′} ( x , y ) = {f}_{e} ( x , y ) + \frac{0.5 ⨯ ( {m}_{o} - {m}_{e} - Δ )}{\sum \sum Δ {L}_{e} ( x , y )} \cdot \\ Δ {L}_{e} ( x , y ) if watermark = 1\end{matrix}$$
$$\begin{matrix}{f}_{o}^{′} ( x , y ) = {f}_{o} ( x , y ) + \frac{0.5 \times ( {m}_{e} - {m}_{o} - Δ ) \cdot M \cdot N}{\sum \sum Δ {L}_{o} ( x , y )} \cdot \\ Δ {L}_{o} ( x , y ) if watermark = - 1\end{matrix}$$
$${f}_{e}^{′} ( x , y ) = {f}_{e} ( x , y ) + \frac{0.5 \times ( {m}_{e} - {m}_{o} + Δ ) \cdot M \cdot N}{\sum \sum Δ {L}_{e} ( x , y )} \cdot Δ {L}_{e} ( x , y )$$
where M is a width of each sub-group, N is a length of each sub-group, fₒ(x,y) and fₑ(x,y) are specific component values at pixel locations (x,y) of units of processing of odd and even frames, respectively, fₒ′(x,y) and fₑ′(x,y) are specific component values at the pixel locations (x,y) after the adding and subtracting are performed, respectively, mₒ and mₑ are averages of the specific component values of the sub-groups of the odd and even frames, respectively, and ΔLₒ(x,y) and ΔLₑ(x,y) are JND values of the specific component values at the pixel locations (x,y), respectively.

3. The method of claim 2, wherein each of the units of processing is a frame or a sub-group.

4. The method of claim 1, wherein the embedment intensity of the watermark information at the third step is modified based on a difference between averages of specific component values at locations of corresponding sub-groups of the successive frames.

5. The method of claim 4, further comprising the steps of determining whether a scene change occurs based on the difference between averages, and skipping to a next frame without embedding the watermarks if the scene change occurs.

6. The method of claim 1, wherein the specific component value at each pixel location is a luminance value.

7. A method of extracting watermarks into and from digital contents in real time using frame averages, comprising:
a first step of dividing each of two successive frames into at least two sub-group;
a second step of calculating averages of specific component values of the sub-groups; and
a third step of extracting watermark information using the calculated averages.

8. The method of claim 7, wherein the third step is performed in such a way that it is determined that the watermark information is “1” if an average of specific component values of a sub-group of an odd frame is larger than an average of specific component values of a corresponding sub-group of an even frame, and it is determined that the watermark information is “−1” if the average of the odd frame is not larger than the average of the even frame.

9. The method of claim 7, further comprising the step of determining that the watermark exists if a correlation value between the extracted watermark information and embedded watermark is larger than a critical value.
